(19) United States
(12) Patent Application Publication
(10) Pub. No.: US 2009/0009698 A1
(43) Pub. Date: Jan. 8, 2009

(54) LIQUID CRYSTAL DISPLAY PANEL

(75) Inventors: Yeon-Kyu MOON, Gunpo-si (KR); Jong-Hwan LEE, Anyang-si (KR); Byeong-Jae AHN, Suwon-si (KR); Yeon-Cu KIM, Asan-si (KR); Hong-Woo LEE, Cheonan-si (KR); Jong Hyuk LEE, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/165,854

(22) Filed: Jul. 1, 2008

(30) Foreign Application Priority Data
Jul. 2, 2007 (KR) 10-2007-0066139

(51) Int. Cl. G02F 1/1333

(52) U.S. Cl. 349/106

(57) ABSTRACT

A liquid crystal display panel includes an array substrate, an opposite substrate, and a color filter arranged on at least one of the array substrate and the opposite substrate. The color filter includes at least one diffusion preventing member that extends in a direction in which a combining member overlaps a driver.

### CROSS-REFERENCE TO RELATED APPLICATION

This application claims priority from and the benefit of Korean Patent Application No. 10-2007-0066139, filed on Jul. 2, 2007, which is hereby incorporated by reference for all purposes as if fully set forth herein.

### BACKGROUND OF THE INVENTION

1. Field of the Invention

The present invention relates to a liquid crystal display panel. More particularly, the present invention relates to a liquid crystal display panel that may have an improved yield.

2. Discussion of the Background

A liquid crystal display panel generally includes an array substrate, a color filter substrate facing the array substrate, a combining member to combine the array substrate and the color filter substrate, and a liquid crystal layer interposed between the array substrate and the color filter substrate.

The array substrate includes a plurality of pixels to display an image, a plurality of gate lines to provide gate signals to the pixels, and a plurality of data lines to provide data signals to the pixels. The color filter substrate includes color filters to display colors using light and a common electrode facing the pixels.

The liquid crystal display panel receives the data signals from a data printed circuit board and receives the gate signals from a gate printed circuit board to display an image.

Recently, a liquid crystal display in which a gate driver to output a gate signal is disposed directly on the array substrate has been developed so that a gate printed circuit board and a gate tape carrier package may be omitted. Such a liquid crystal display has various advantages, for example, it may be thin and have a low manufacturing cost.

However, when the gate driver is disposed directly on the array substrate, the combining member partially overlaps the gate driver, thereby blocking a portion of the light irradiated onto the combining member. As a result, the combining member may not be completely cured, which may allow liquid crystals of the liquid crystal layer to be contaminated by contaminants generated by the uncured portions of the combining member. Further, when contaminated liquid crystals move toward the display area of the liquid crystal display panel, the display quality of the liquid crystal display panel may deteriorate.

### SUMMARY OF THE INVENTION

The present invention provides a liquid crystal display panel having an improved display quality.

Additional features of the invention will be set forth in the description which follows, and in part will be apparent from the description, or may be learned by practice of the invention.

The present invention discloses a liquid crystal display panel including an array substrate, an opposite substrate, a diffusion preventing member, a combining member, a liquid crystal layer, and a color filter. The array substrate includes a display area and a peripheral area. The display area includes a plurality of pixel areas arranged in an array shape and the peripheral area is adjacent to the display area. The array substrate also includes a plurality of pixels arranged in the pixel areas in one-to-one correspondence relationships and at least one driver disposed in the peripheral area to provide a driving signal to the pixels. The opposite substrate faces the array substrate. The color filter is disposed on at least one of the array substrate and the opposite substrate, and the diffusion preventing member is disposed in the display area or the peripheral area. The diffusion preventing member is disposed on at least one of the array substrate and the opposite substrate. The combining member is disposed between the array substrate and the opposite substrate and outside of the diffusion preventing member and spaced apart from the diffusion preventing member.

The present invention also discloses a liquid crystal display panel includes an array substrate, an opposite substrate, a color filter, a combining member, a liquid crystal layer, and at least one barrier wall. The array substrate includes a display area and a peripheral area. The display area includes a plurality of pixels and the peripheral area is adjacent to the display area. The array substrate also includes at least one driver disposed in the peripheral area to provide driving signals to the pixels. The opposite substrate faces the array substrate. The combining member is disposed between the array substrate and the opposite substrate and in the peripheral area to combine the array substrate and the opposite substrate. The barrier wall is disposed between the array substrate and the opposite substrate and between the display area and the combining member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a liquid crystal display apparatus according to an exemplary embodiment of the present invention.

FIG. 2 is a sectional view taken along line I-I′ of FIG. 1.

FIG. 3 is a plan view showing an array substrate of FIG. 1.

FIG. 4 is a plan view showing an exemplary embodiment of a color filter in the liquid crystal display apparatus of FIG. 1.

FIG. 5A and FIG. 5B are graphs of the after-image of a liquid crystal display panel over time.

FIG. 6 is a plan view showing a color filter according to another exemplary embodiment of the present invention.

FIG. 7 is a plan view showing a color filter according to another exemplary embodiment of the present invention.

FIG. 8 is a sectional view taken along line II-II′ of FIG. 7.

FIG. 9 is a plan view showing a liquid crystal display apparatus according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to”, or “coupled to” another element or layer, it can be directly on, directly connected to, or directly coupled to the other element or layer or intervening elements or layers may be present. In contrast, when an element is referred to as being “directly on,” “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

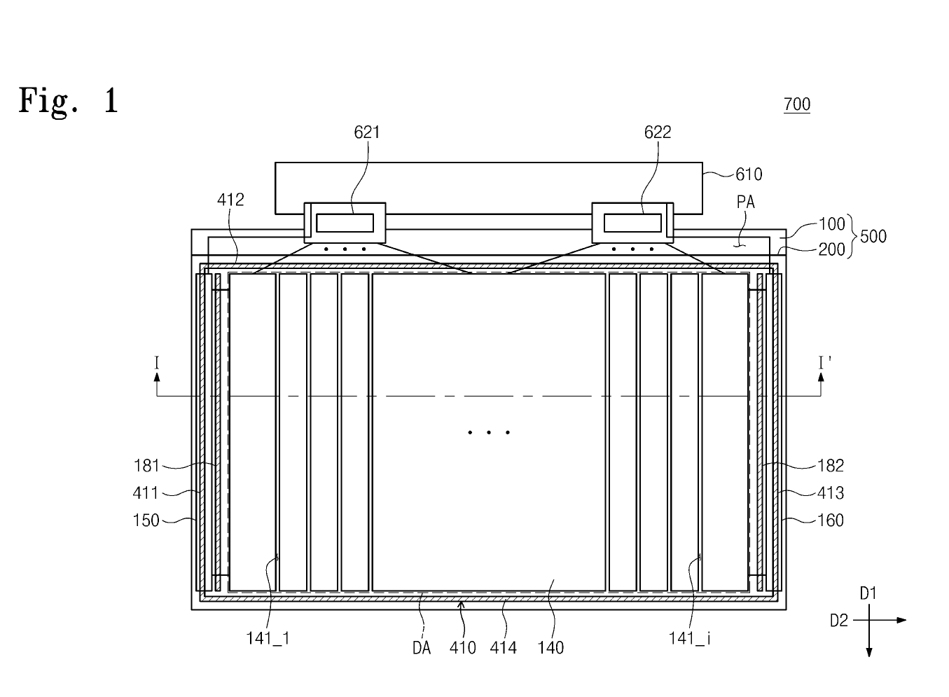

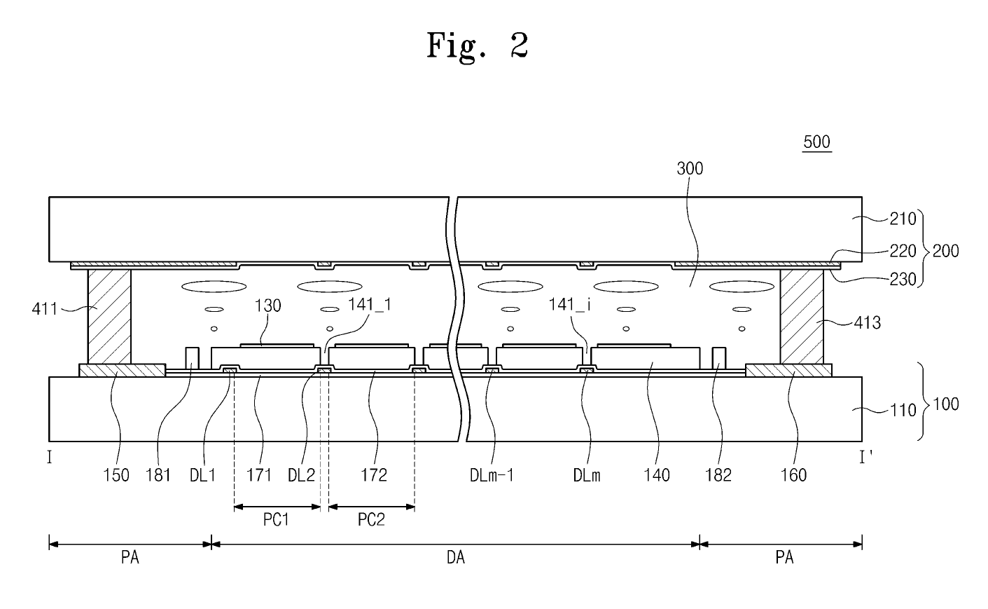

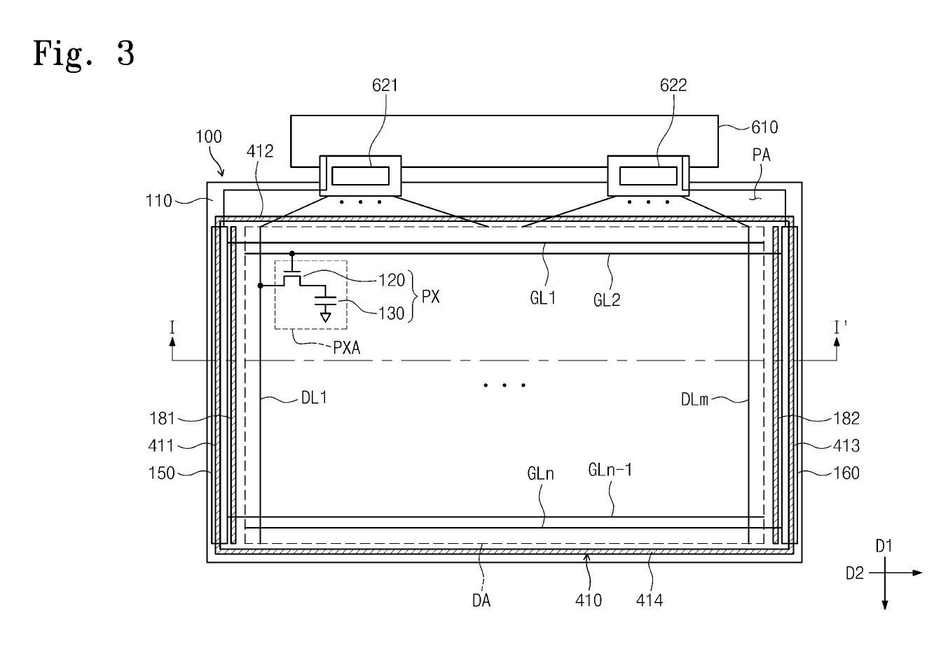

FIG. 1 is a plan view showing a liquid crystal display apparatus according to an exemplary embodiment of the present invention, FIG. 2 is a sectional view taken along line I-I′ of FIG. 1, and FIG. 3 is a plan view showing an array substrate of FIG. 1. In FIG. 3, a color filter shown in FIG. 1 has been omitted in order to describe lines, such as data lines DL1˜DLm and gate lines GL1˜GLn, and pixels PX of the array substrate 100 in detail.

Referring to FIG. 1, a liquid crystal display apparatus 700 includes a liquid crystal display panel 500 to display an image, a printed circuit board 610 to output a gate control signal and a data control signal, and first and second tape carrier packages 621 and 622 to connect the liquid crystal display panel 500 to the printed circuit board 610.

The liquid crystal display panel 500 includes an array substrate 100, an opposite substrate 200 facing the array substrate 100, a liquid crystal layer 300 interposed between the array substrate 100 and the opposite substrate 200, and a sealant 410 to combine the array substrate 100 and the opposite substrate 200.

Referring to FIG. 1, FIG. 2, and FIG. 3, the array substrate 100 includes a first base substrate 110, first to m^{th} data lines DL1˜DLm, first to n^{th} gate lines GL1˜GLn, pixels PX, a color filter 140, a first gate driver 150, and a second gate driver 160. In the present exemplary embodiment, m and n are natural numbers equal to or greater than 1.

The first base substrate 110 includes a display area DA on which the image is displayed and a peripheral area PA adjacent to the display area DA defined thereon, and the display area DA includes a plurality of pixel areas PXA.

The first to m^{th} data lines DL1˜DLm are arranged in the display area DA of the first base substrate 110 to transmit a data signal. The first to m^{th} data lines DL1˜DLm extend in a first direction D1 and are arranged at regular intervals in a second direction D2, which is substantially perpendicular to the first direction D1.

The first to n^{th} gate lines GL1˜GLn are arranged in the display area DA of the first base substrate 110 to transmit a gate signal. The first to n^{th} gate lines GL1˜GLn extend in the second direction D2 and are arranged at regular intervals in the first direction D1.

The first to m^{th} data lines DL1˜DLm are insulated from and cross the first to gate lines GL1˜GLn to define the pixel areas PXA. Each pixel area PXA has a shape in which a length in the first direction D1 is greater than a length in the second direction D2.

The pixels PX are respectively disposed in the pixel areas PXA of the first base substrate 110. Each pixel PX includes a thin film transistor 120 to switch a pixel voltage corresponding to the image and a pixel electrode 130 connected to the thin film transistor 120. The thin film transistor 120 is connected to a corresponding data line among the first to m^{th} data lines DL1˜DLm and a corresponding gate line among the first to n^{th} gate lines GL1˜GLn. For example, the thin film transistor 120 disposed in a pixel area PXA that is defined by the first gate line GL1 and the first data line DL1 includes a gate electrode connected to the first gate line GL1, a source electrode connected to the first data line DL1, and a drain electrode connected to the pixel electrode 130 to receive the pixel voltage.

The array substrate 100 further includes a gate insulating layer 171 and a protective layer 172 to protect the data lines DL1˜DLm, the gate lines GL1˜GLn, and the thin film transistors 120. The gate insulating layer 171 is disposed on the first base substrate 110 to cover the first to n^{th} gate lines GL1˜GLn. The protective layer 172 is formed on the gate insulating layer 171 to cover the first to m^{th} data lines DL1˜DLm and the thin film transistor 120.

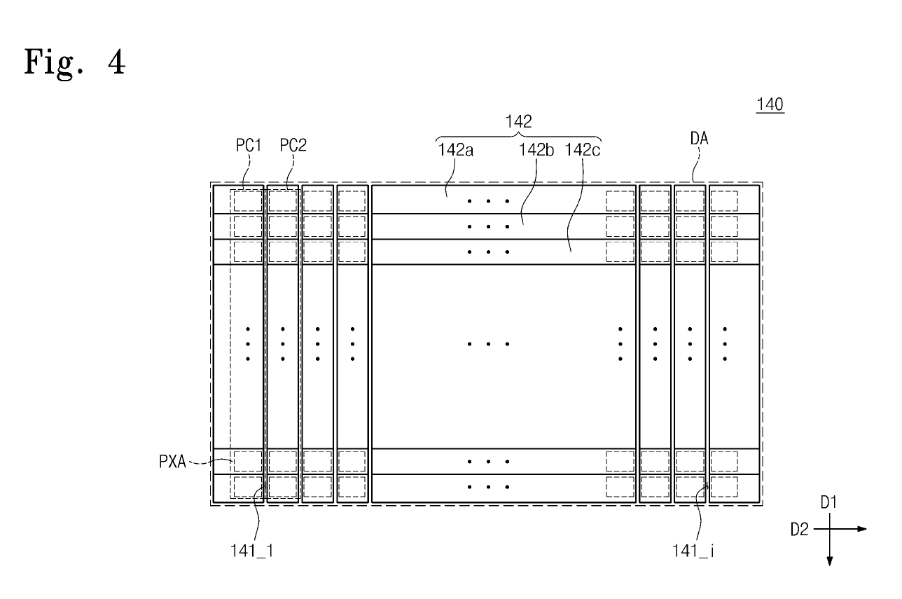

The color filter 140 to display a predetermined color using light is disposed on the protective layer 172. In the present exemplary embodiment, the color filter 140 is arranged on the array substrate 100. However, the color filter 140 may be arranged on the opposite substrate 200. The color filter 140 is disposed in the display area DA, and the pixel electrode 130 is disposed on the color filter 140. A detailed description of the color filter 140 will be described below with reference to FIG. 4.

The first gate driver 150 and the second gate driver 160 are disposed in the peripheral area PA of the first base substrate 110. The first and second gate drivers 150 and 160 receive the gate control signal to output the gate signal and provide the gate signal to the first to n^{th} gate lines GL1˜-GLn. Particularly, the first and second gate drivers 150 and 160 are positioned at opposite ends of the array substrate 100 and the first to n^{th} gate lines GL1˜GLn are interposed therebetween. That is, the first gate driver 150 may be arranged adjacent to first ends of the first to n^{th} gate lines GL1˜GLn, and the second gate driver 160 may be arranged adjacent to second ends of the first to n^{th} gate lines GL1˜GLn.

The first gate driver 150 is connected to odd-numbered gate lines among the first to n^{th} gate lines GL1˜GLn and provides the gate signal to the odd-numbered gate lines. The second gate driver 160 is connected to even-numbered gate lines among the first to n^{th} gate lines GL1˜GLn and provides the gate signal to the even-numbered gate lines.

The first and second gate drivers 150 and 160 are formed simultaneously with the pixels PX through the same process.

The opposite substrate 200 is arranged at an upper portion of the array substrate 100. The opposite substrate 200 includes a second base substrate 210, a black matrix 220, and a common electrode 230. The second base substrate 210 is arranged to face the first base substrate 110. The black matrix 220 is disposed on the second base substrate 210 to block the light. The black matrix 220 is disposed in the peripheral area PA and in a region that surrounds the pixel area PXA. The common electrode 230 is disposed on the second base substrate 210 to cover the black matrix 220. The common electrode 230 faces the pixel electrodes 130 of the array substrate 100 with the liquid crystal layer 300 interposed therebetween and receives a common voltage.

The liquid crystal layer 300 controls the transmittance of light advancing from the array substrate 100 according to an electric field generated between the common electrode 230 and the pixel electrodes 130.

The sealant 410 is disposed between the array substrate 100 and the opposite substrate 200 in the peripheral area PA. The sealant 410 surrounds the display area DA and combines the array substrate 100 and the opposite substrate 200 to seal the liquid crystal layer 300. The sealant 410 may include a light-curable type sealing material that is cured by ultraviolet rays.

More specifically, the sealant 410 may include a first line 411, a second line 412, a third line 413, and a fourth line 414. The first line 411 may extend in the first direction D1 and be disposed on the first gate driver 150 to partially overlap the first gate driver 150. The second line 412 may extend from the first line 411 in the second direction D2 and may be arranged adjacent to the first and second TCP (tape carrier package)s 621 and 622. The third line 413 may extend from the second line 412 in the first direction D1 and may face the first line 411 with the color filter 140 therebetween. Also, the third line 413 may be disposed on the second gate driver 160 to partially overlap the second gate driver 160. The fourth line 414 may extend from the third line 413 in the second direction D2 and may face the second line 412 with the color filter 140 therebetween.

The sealant 410 may be cured by ultraviolet rays provided from under the array substrate 100. That is, since the black matrix 220 to block the ultraviolet rays is disposed in the peripheral area PA of the opposite substrate 200, the ultraviolet rays may be provided from under the array substrate 100. However, since the first and third lines 411 and 413 overlap the first and second gate drivers 150 and 160, respectively, the ultraviolet rays are blocked by the first and second gate drivers 150 and 160, so the first and third lines 411 and 413 may not be completely cured by the ultraviolet rays. When the first and third lines 411 and 413 are not completely cured, contaminants may be generated in the first and third lines 411 and 413, which may contaminate the liquid crystals of the liquid crystal layer 300. As a result, contaminated liquid crystals may flow into the display area DA, thereby causing edge blur and after-images.

To prevent edge blur and after-images, the color filter 140 includes a plurality of diffusion preventing members 141_1˜141_{—}i, which prevent the contaminated liquid crystals from flowing into the display area DA. In the present exemplary embodiment, i is a natural number equal to or greater than 1.

Hereinafter, a configuration of the color filter 140 will be described in detail with reference to FIG. 4.

FIG. 4 is a plan view showing an exemplary embodiment of a color filter in the liquid crystal display apparatus of FIG. 1.

Referring to FIG. 1 and FIG. 4, the color filter 140 includes a plurality of color pixels 142 that receives light provided from under the array substrate 100 to display color. The color pixels 142 include red, green, and blue color pixels 142a, 142b, and 142c. The red, green, and blue color pixels 142a, 142b, and 142c are sequentially arranged along the first direction D1. Each color pixel 142 is a different color than a color pixel adjacent thereto in the first direction D1. Each of the red, green, and blue color pixels 142a, 142b, and 142c is successively disposed along corresponding pixel areas PXA arranged in the second direction D2. That is, the color pixels 142 are disposed in the pixel areas PXA in one-to-one correspondence relationships, and the color pixels 142 arranged in the same row of the pixel areas PXA have the same color. For instance, a red color pixel 142a may be disposed in a first row of the pixel areas PXA, a green color pixel 142b may be disposed in a second row of the pixel areas PXA, and a blue color pixel 142c may be disposed in a third row of the pixel areas PXA.

In the present exemplary embodiment, each of the red, green, and blue color pixels 142a, 142b, and 142c does not overlap a color pixel adjacent thereto. However, in other exemplary embodiments, the red, green, and blue color pixels 142a, 142b, and 142c may partially overlap adjacent color pixels.

Referring to FIG. 2 and FIG. 4, the diffusion preventing members 141_1˜141_{—}i include first to i^{th} diffusion preventing members 141_1˜141_{—}i and are disposed parallel to the first direction D1.

Particularly, the color filter 140 may be removed along the first direction D1 and the first to i^{th} diffusion preventing members 141_1˜141_{—}i may be successively disposed along the pixel areas PXA arranged in the first direction D1. The protective layer 172 that is disposed under the color filter 140 is partially exposed through the first to i^{th} diffusion preventing members 141_1˜141_{—}i.

Each first to i^{th} diffusion preventing member 141_1˜141_{—}i is disposed between two pixel areas that are adjacent to each other in the second direction D2. That is, each diffusion preventing member 141_1˜141_{—}i is disposed in a region between two adjacent columns of the pixel areas PXA. For instance, the first diffusion preventing member 141_1 may be disposed between a first column PC1 and a second column PC2 among columns of the pixel areas PXA. Accordingly, the color filter 140 may be divided corresponding to the columns of the pixel areas PXA by the first to i^{th} diffusion preventing members 141_1˜141_{—}i.

Thus, grooves defined by the first to i^{th} diffusion preventing members 141_1˜141_{—}i extend in the first direction D1 are disposed on the array substrate 100. The contaminated liquid crystals generated when the sealant 410 is not completely cured move in the first direction D1 along the grooves defined by the first to i^{th} diffusion preventing members 141_1˜141_{—}i. In other words, the first to i^{th} diffusion preventing members 141_1˜141_{—}i may prevent the contaminated liquid crystals from moving in the second direction D2 and being diffused inside the display area DA. Consequently, edge blur and after-images on the liquid crystal display panel 500 may be prevented, thereby improving the display quality of the liquid crystal display panel 500.

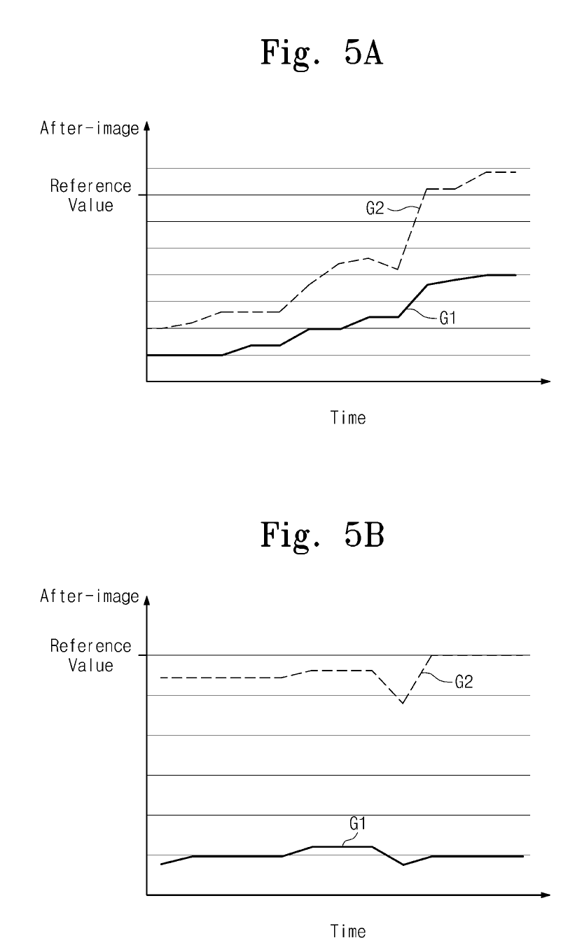

FIG. 5A and FIG. 5B are graphs showing the after-image of a liquid crystal display panel over time.

FIG. 5A is a graph showing the degree of after-image in the liquid crystal display panel 500 of FIG. 1 and in a conventional liquid crystal display panel, on which white and black colors are displayed in a checker pattern.

Referring to FIG. 5A, the after-image gradually increases in both the exemplary liquid crystal display panel G1 and the conventional liquid crystal display panel G2 as time lapses. In the conventional liquid crystal display panel G2, the degree of the after-image exceeds a reference value applied as a factor to determine whether the liquid crystal display panel is defective or not over time. However, in the exemplary liquid crystal display panel G1, the degree of the after-image is maintained under the reference value.

FIG. 5B is a graph showing the degree of after-image in the exemplary liquid crystal display panel G1 and the conventional liquid crystal display panel G2, on which a windows background image that is originally provided is displayed.

Referring to FIG. 5B, in the exemplary liquid crystal display panel G1, the degree of the after-image is maintained under the reference value over time. However, in the conventional liquid crystal display panel G2, the degree of the after-image exceeds the reference value over time.

As described above, the exemplary liquid crystal display panel G1 may prevent contaminated liquid crystals from flowing to the display area DA (shown in FIG. 1) using the first to i^{th} diffusion preventing members 141_1˜141_{—}i, so the degree of after-image may be maintained under the reference value. However, in the conventional liquid crystal display panel G2, the contaminated liquid crystals easily flow to the display area DA on which the image is displayed, so it may be difficult to continuously maintain the degree of the after-image under the reference value.

Referring again to FIG. 1 and FIG. 2, the array substrate 100 further includes a first barrier wall 181 and a second barrier wall 182. In the present exemplary embodiment, the first and second barrier walls 181 and 182 are disposed on the array substrate 100. However, the first and second barrier walls 181 and 182 may be disposed on the opposite substrate 200. Also, in FIG. 1 and FIG. 2, the liquid crystal display panel 500 includes only two barrier walls 181 and 182, but the number of barrier walls may be increased or decreased according to a size of the liquid crystal panel 500 and the number of the gate drivers.

The first and second barrier walls 181 and 182 are disposed in the peripheral area PA on the same layer as the color filter 140. The first and second barrier walls 181 and 182 may include the same material as the color filter 140. The first and second barrier walls 181 and 182 may include any of the red, green, and blue color pixels 142a, 142b, and 142c of the color filter 140. Further, the first and second barrier walls 181 and 182 may be formed simultaneously with the color filter 140 through the same process.

More specifically, the first barrier wall 181 may be positioned between the first line 411 of the sealant 410 and the color filter 140 and spaced apart from the first line 411 and the color filter 140. The first barrier wall 181 may be disposed along the first line 411.

The first barrier wall 181 may prevent contaminants generated in the first line 411 from moving in the second direction D2 and flowing into the display area DA. That is, although the first line 411 may not be completely cured and the liquid crystals contacting the first line 411 may be contaminated, the first barrier wall 181 may prevent the contaminated liquid crystals from flowing into the display area DA. Thus, the edge blur and the after-image on the liquid crystal display panel 500 may be prevented, thereby improving the display quality of the liquid crystal display panel 500.

In the present exemplary embodiment, the first barrier wall 181 is disposed between the first gate driver 150 and the color filter 140 in a plan view. However, the first barrier wall 181 may overlap the first gate driver 150.

The second barrier wall 182 extends in the first direction D1 and faces the first barrier wall 181 with the color filter 140 therebetween. The second barrier wall 182 is positioned between the third line 413 of the sealant 410 and the color filter 140 and spaced apart from the third line 413 and the color filter 140. The second barrier wall 182 may be successively formed along the third line 413.

The second barrier wall 182 may prevent contaminants generated in the third line 413 from moving in the second direction D2 and flowing into the display area DA. That is, although the third line 413 may not be completely cured and the liquid crystals that contact the third line 413 may be contaminated, the second barrier wall 182 may prevent the contaminated liquid crystals from flowing into the display area DA. Accordingly, edge blur and after-images on the liquid crystal display panel 500 may be prevented, so that the display quality of the liquid crystal display panel 500 may be improved.

In the present exemplary embodiment, the second barrier wall 182 is disposed between the second gate driver 160 and the color filter 140 in a plan view, but the second barrier wall 182 may overlap the second gate driver 160.

Referring to FIG. 1 and FIG. 3, the printed circuit board 610 is arranged adjacent to one side of the LCD panel 500, and the first and second TCPs 621 and 622 are connected between the array substrate 100 and the printed circuit board 610. Particularly, the printed circuit board 610 receives an image signal corresponding to an image and outputs a data control signal and a gate control signal. First ends of the first and second TCPs 621 and 622 are attached to the printed circuit board 610, and second ends of the first and second TCPs 621 and 622, which are opposite to the first ends, are attached to the peripheral area PA of the array substrate 100. The first and second TCPs 621 and 622 receive the data control signal from the printed circuit board 610 to output the data signal to the first to m^{th} data lines DL1˜DLm. Also, the first and second TCPs 621 and 622 provide the gate control signal from the printed circuit board 610 to the first and second gate drivers 150 and 160.

In the present exemplary embodiment, the liquid crystal display apparatus 700 includes two TCPs 621 and 622, however, the number of the TCPs may be increased or decreased according to the number of data lines DL1˜DLm.

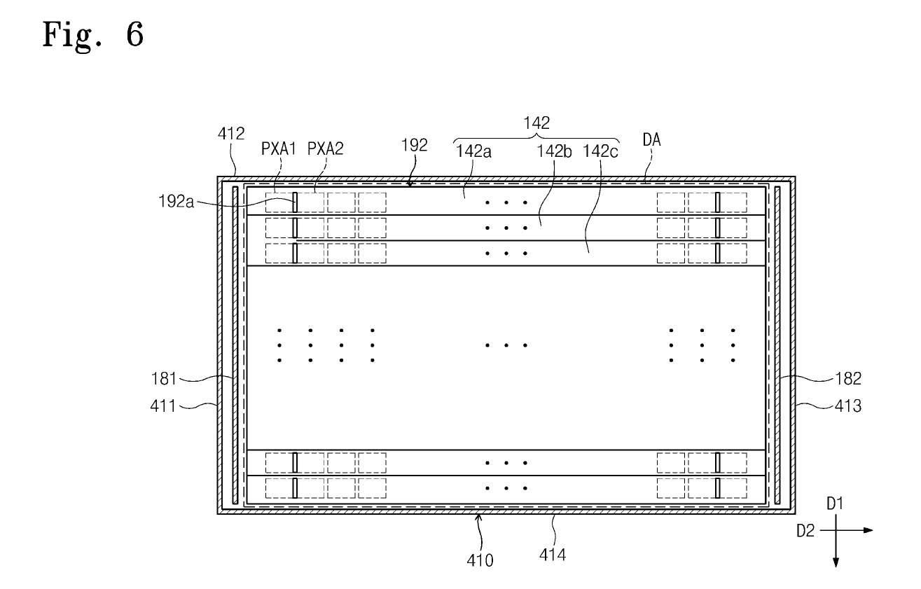

FIG. 6 is a plan view showing a color filter according to another exemplary embodiment of the present invention. In FIG. 6, the same reference numerals denote the same elements in FIG. 1, FIG. 2, FIG. 3, and FIG. 4, and thus, detailed descriptions of the same elements will be omitted.

Referring to FIG. 6, a color filter 192 is formed in a display area DA of a first base substrate 110 (shown in FIG. 1) and includes a plurality of color pixels 142 to display color using light. The color pixels 142 are arranged along a first direction D1, and each color pixel 142a, 142b, and 142c is successively disposed along corresponding pixel areas PXA arranged in a second direction D2, which is perpendicular to the first direction D1.

The color filter 192 may include a plurality of diffusion preventing members 192a, which each include a hole formed by partially removing the color filter 192 along the first direction D1, so that a protective layer 172 (shown in FIG. 2) disposed under the color filter 192 is partially exposed through the diffusion preventing members 192a.

Each diffusion preventing member 192a is disposed between two pixel areas PXA1 and PXA2 that are adjacent to each other in the second direction D2. That is, the diffusion preventing members 192a are disposed between two columns of the pixel areas PXA1 and PXA2 that are adjacent to each other along the first direction D1. The diffusion preventing members 192a are also spaced apart from each other in the first direction D1.

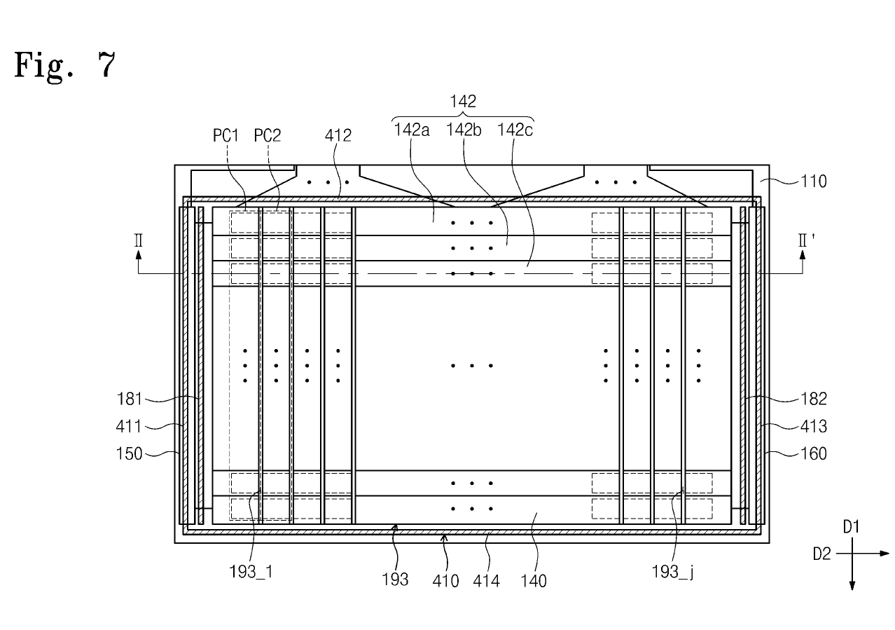

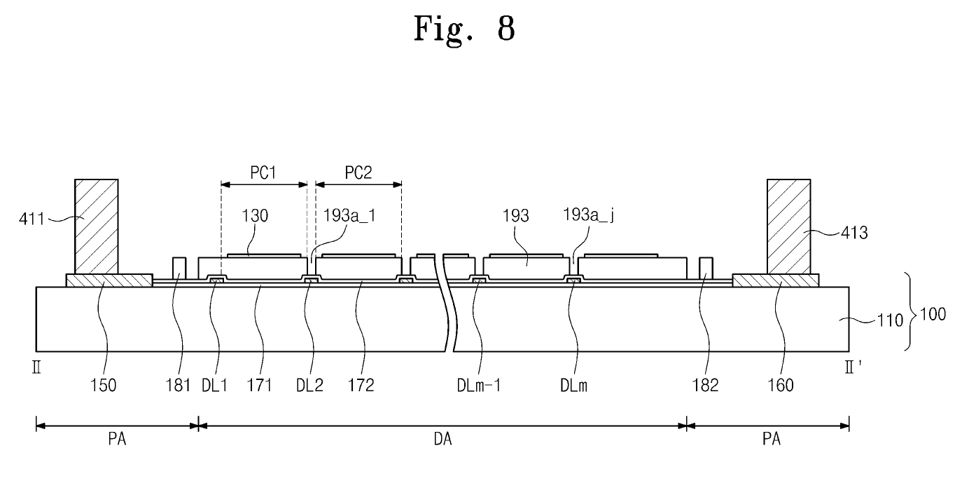

FIG. 7 is a plan view showing a color filter according to another exemplary embodiment of the present invention, and FIG. 8 is a sectional view taken along line II-II′ of FIG. 7. In FIG. 7 and FIG. 8, the same reference numerals denote the same elements in FIG. 1, FIG. 2, FIG. 3, and FIG. 4, and thus, detailed descriptions of the same elements will be omitted.

Referring to FIG. 7 and FIG. 8, a color filter 193 is disposed in a display area DA of a first base substrate 110 and includes a plurality of color pixels 142 to display color using light. The color pixels 142 are arranged in a first direction D1, and each color pixel 142a, 142b, and 142c is successively disposed along corresponding pixel areas arranged in a second direction D2, which is perpendicular to the first direction D1.

The color filter 193 is provided with first to j^{th} diffusion preventing members 193a_1˜193a_{—}j, which each have a groove shape formed by partially removing the color filter 193 along its upper portion. In the present exemplary embodiment, j is a natural number equal to or greater than 1. Each first to j^{th} diffusion preventing member 193a_1˜193a_{—}j may be formed by partially removing the upper portion of the color filter 193 along the first direction D1. Each diffusion preventing member 193a_1˜193a_{—}j may be successively formed between two adjacent columns of the pixel areas along the first direction D1. However, the diffusion preventing members 193a_1˜193a_{—}j may alternatively be arranged in plural between two adjacent columns of the pixel areas along the first direction D1, as in the color filter 192 shown in FIG. 6.

Each first to j^{th} diffusion preventing members 193a_1˜193a_{—}j is disposed between two pixel areas adjacent to each other in the second direction D2. In other words, each diffusion preventing member 193a_1˜193a_{—}j is disposed in a region between two adjacent columns PC1 and PC2 of the pixel areas PXA in one-to-one fashion. For example, the first diffusion preventing member 193a 1 is disposed between a first column PC1 and a second column PC2 among the columns of the pixel areas PXA.

As described above, grooves defined by the first to j^{th} diffusion preventing members 193a_1˜193a_{—}j extend in the first direction D1 are disposed on the array substrate 100, and the first to j^{th} diffusion preventing members 193a_1˜193a_{—}j having the groove shapes may prevent contaminated liquid crystals generated from non-cured sealant from moving in the second direction D2. That is, since the first to j^{th} diffusion preventing members 193a_1˜193a_{—}j prevent contaminated liquid crystals from diffusing inside the display area DA, the edge blur and the after-image on the liquid crystal display panel 500 may be prevented, thereby improving the display quality of the liquid crystal display panel 500.

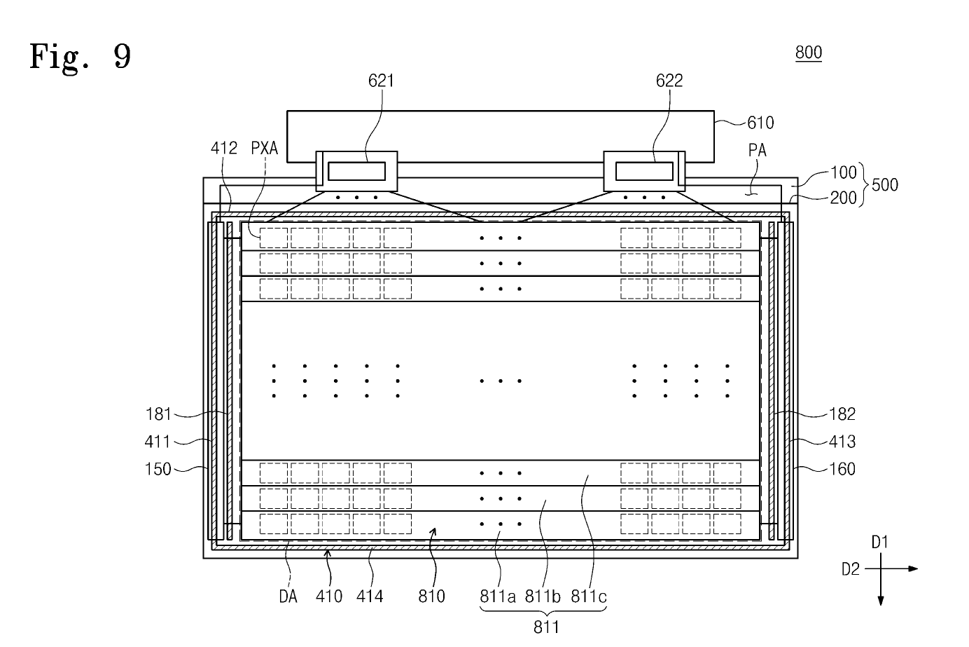

FIG. 9 is a plan view showing a liquid crystal display apparatus according to another exemplary embodiment of the present invention. In FIG. 9, the same reference numerals denote the same elements in FIG. 1, and thus detailed descriptions of the same elements will be omitted.

Referring to FIG. 9, a liquid crystal display apparatus 800 includes a liquid crystal display panel 500 to display an image, a printed circuit board 610 to output a gate control signal and a data control signal, and first and second TCPs 621 and 622 to connect the printed circuit board 610 to the liquid crystal display panel 500.

The liquid crystal display panel 500 includes an array substrate 100, an opposite substrate 200 facing the array substrate 100, a liquid crystal layer 300 interposed between the array substrate 100 and the opposite substrate 200, and a sealant 410 to combine the array substrate 100 and the opposite substrate 200.

The array substrate 100 includes a first base substrate 110, first to m^{th} data lines DL1˜DLm (refer to FIG. 3), first to n^{th} gate lines GL1˜GLn (refer to FIG. 3), a plurality of pixels, a color filter 810, a first gate driver 150, a second gate driver 160, a first barrier wall 181, and a second barrier wall 182.

The color filter 810 is disposed in a display area DA of the array substrate 100 and includes a plurality of color pixels 811 to display a color in response to a light provided from under the array substrate 100. The color pixels 811 include red, green, and blue color pixels 811a, 811b, and 811c, and the red, green, and blue color pixels 811a, 811b, and 811c are arranged parallel to each other in a first direction D1 along which a first line 411 and a third line 413 of the sealant 410 extend. Each color pixel 811a, 811b, and 811c is a different color than a color pixel adjacent thereto in the first direction D1. The red, green, and blue color pixels 811a, 811b, and 811c extend in a second direction D2 that is perpendicular to the first direction D1, and the red, green, and blue color pixels 811a, 811b, and 811c are successively disposed along corresponding pixel areas arranged in the second direction D2.

In the present exemplary embodiment, each of the red, green, and blue color pixels 811a, 811b, and 811c does not overlap a color pixel adjacent thereto. However, each of the red, green, and blue color pixels 811a, 811b, and 811c may overlap the adjacent color pixel.

The first and second barrier walls 181 and 182 are disposed in a peripheral area PA of the array substrate 100 and on the same layer as the color filter 810. In the present exemplary embodiment, the first and second barrier walls 181 and 182 are disposed on the array substrate 100, but the first and second barrier walls 181 and 182 may alternatively be disposed on the opposite substrate 200. Also, the liquid crystal display panel 500 of the exemplary embodiment includes two barrier walls 181 and 182, however, the number of the barrier walls may be increased or decreased according to a size of the liquid crystal display panel 500 and the number of the gate drivers.

The first and second barrier walls 181 and 182 may include the same material as the color filter 810. Each of the first and second barrier walls 181 and 182 may include any of the red, green, and blue color pixels 811a, 811b, and 811c of the color filter 810. Further, the first and second barrier walls 181 and 182 may be formed simultaneously with the color filter 810 through the same process.

The first barrier wall 181 is arranged between the first line 411 of the sealant 410 and the color filter 810 and spaced apart from the first line 411 and the color filter 810. Therefore, although the first line 411 may not be completely cured and the liquid crystals that contact the first line 411 may be contaminated, the first barrier wall 181 may prevent contaminated liquid crystals from in the second direction D2. Thus, the first barrier wall 181 may prevent contaminated liquid crystals from flowing into the display area DA, and the edge blur and the after-image on the liquid crystal display panel 500 may be prevented, thereby improving the display quality of the liquid crystal display panel 500. Meanwhile, the second barrier wall 182 is arranged between the third line 413 of the sealant 410 and the color filter 810 and spaced apart from the third line and the color filter 810. Accordingly, although the liquid crystals that contact the third line 413 may be contaminated because the third line 413 may not be completely cured, the second barrier wall 182 may prevent contaminated liquid crystals from flowing into the display area DA. Consequently, edge blur and after-images on the liquid crystal display panel 500 may be prevented, so the display quality of the liquid crystal display panel 500 may be improved.

According to the exemplary embodiments of the present invention, the liquid crystal display panel includes barrier walls and diffusion preventing members in order to prevent the contaminants, which may be generated due to the non-cured sealant overlapping the gate driver, from flowing into the display area. However, aside from the gate driver, a data driver or other drivers providing an electrical signal to the liquid crystal display panel may overlap the sealant, and the sealant in the overlapped region may not be completely cured. Thus, the barrier walls or the diffusion preventing members described in the exemplary embodiments of the present invention may be disposed corresponding to the data driver or other drivers that prevent the sealant from being completely cured. In this case, the barrier walls and the diffusion preventing members may be disposed along a direction in which the data driver or other drivers are elongated.

According to the above, the color filter may be partially removed to define the diffusion preventing members thereon. The diffusion preventing members prevent contaminated liquid crystals from flowing into the display area when the sealant in the region where the gate driver and the sealant overlap each other is not completely cured and the liquid crystals are contaminated. Thus, edge blur and after-images on the liquid crystal display panel may be prevented, so that the yield of the liquid crystal display panel may be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display panel, comprising:
an array substrate comprising a display area comprising a plurality of pixel areas arranged in an array, a peripheral area adjacent to the display area, a plurality of pixels arranged in the pixel areas in one-to-one correspondence relationships and at least one driver disposed in the peripheral area to provide a driving signal to the pixels;
an opposite substrate facing the array substrate;
a color filter disposed on at least one of the array substrate and the opposite substrate;
a liquid crystal layer interposed between the array substrate and the opposite substrate;
a diffusion preventing member disposed in the display area or the peripheral area, the diffusion preventing member being disposed on at least one of the array substrate and the opposite substrate; and
a combining member disposed between the array substrate and the opposite substrate, the combining member being arranged outside the diffusion preventing member and spaced apart from the diffusion preventing member.

2. The liquid crystal display panel of claim 1, wherein the color filter comprises at least two color pixels, the driver partially overlaps the combining member along a first direction, and each color pixel extends in a second direction that is perpendicular to the first direction, the at least two color pixels being arranged in the first direction.

3. The liquid crystal display panel of claim 2, wherein the diffusion preventing member comprises gaps in the color filter and a layer disposed under the color filter is exposed by the gaps.

4. The liquid crystal display panel of claim 2, wherein the diffusion preventing member comprises a groove in the color filter, the depth of the groove not exceeding the thickness of the color filter.

5. The liquid crystal display panel of claim 4, wherein the diffusion preventing member comprises plural portions, and the diffusion preventing members are arranged in the first direction.

6. The liquid crystal display panel of claim 3, wherein the diffusion preventing member extends along the pixel areas arranged in the first direction.

7. The liquid crystal display panel of claim 1, wherein the diffusion preventing member is positioned adjacent to the combining member.

8. The liquid crystal display panel of claim 2, wherein the diffusion preventing member is disposed in a region between two pixel areas that are adjacent to each other in the second direction.

9. The liquid crystal display panel of claim 1, further comprising at least one barrier wall arranged between the color filter and the combining member and spaced apart from the color filter and the combining member.

10. The liquid crystal display panel of claim 9, wherein the barrier wall comprises the same material as the color filter and the color filter comprises at least one color pixel.

11. The liquid crystal display panel of claim 9, wherein the driver partially overlaps the combining member along a first direction, and the barrier wall is extends along the first direction.

12. The liquid crystal display panel of claim 11, wherein the color filter comprises at least two color pixels, and each color pixel extends along a second direction that is perpendicular to the first direction, the at least two color pixels being arranged in the first direction.

13. The liquid crystal display panel of claim 1, wherein the combining member comprises a light-curable material.

14. The liquid crystal display panel of claim 1, wherein the driver comprises at least one driver of a gate driver to provide a gate signal to the array substrate and a data driver to provide a data signal to the array substrate.

15. A liquid crystal display panel, comprising:
an array substrate comprising a display area comprising a plurality of pixels and a peripheral area adjacent to the display area, and at least one driver disposed in the peripheral area to provide driving signals to the pixels;
an opposite substrate facing the array substrate;
a color filter disposed on at least one of the array substrate and the opposite substrate;
a liquid crystal layer interposed between the array substrate and the opposite substrate;
a combining member disposed in the peripheral area between the array substrate and the opposite substrate to combine the array substrate and the opposite substrate; and
at least one barrier wall disposed between the array substrate and the opposite substrate and between the display area and the combining member.

16. The liquid crystal display panel of claim 15, wherein the driver partially overlaps the combining member along a first direction, the color filter is arranged in the first direction and extends along a second direction that is perpendicular to the first direction, the color filter comprises at least two color pixels, and the color filter is disposed on one of the array substrate and the opposite substrate corresponding to the display area.

17. The liquid crystal display panel of claim 16, wherein the barrier wall extends along the first direction.

18. The liquid crystal display panel of claim 15, wherein the barrier wall comprises at least one color pixel.

19. The liquid crystal display panel of claim 15, wherein the combining member comprises a light-curable material.

20. The liquid crystal display panel of claim 15, wherein the driver comprises at least one driver of a gate driver to provide a gate signal to the array substrate and a data driver to provide a data signal to the array substrate.
